(19) United States
(12) Patent Application Publication
(10) Pub. No.: US 2006/0284593 A1
(43) Pub. Date: Dec. 21, 2006

(54) Wireless battery charging system and method

(76) Inventors: Louis L. Nagy, Warren, MI (US); Francis E. Szczublewski, Macomb, MI (US); Laci J. Jalics, Ray, MI (US); Mark K. Krage, Troy, MI (US); Andrzej M. Pawlak, Rochester Hills, MI (US)

Correspondence Address: DELPHI TECHNOLOGIES, INC., M/C 480-410-202, PO BOX 5052, TROY, MI, 48007, US

(21) Appl. No.: 11/432,878

(22) Filed: May 12, 2006

Related U.S. Application Data
(60) Provisional application No. 60/692,371, filed on Jun. 21, 2005.

(51) Int. Cl. H02J 7/00

(52) U.S. Cl. 320/109

(57) ABSTRACT

A wireless battery charging system and method includes a self-structuring antenna system for monitoring a wide area and detecting wireless devices within the area, a transceiver for establishing two-way communication with a wireless device detected within the area, and a computer for adjusting the self-structuring antenna system to focus electromagnetic energy beamed to the wireless device according to information received from the wireless device detected within the area. The wireless battery charging system and method preferably includes a charging cradle that has a self-structuring antenna system that monitors a cradle charging area and detects a wireless device in the cradle, a transceiver for establishing two-way communication with the wireless device in the cradle, and a computer for adjusting the self-structuring antenna system to focus electromagnetic near-field energy to the wireless device in the cradle according to information received from the wireless device in the cradle.

### RELATED PATENT APPLICATION

Applicant claims benefit of the filing date of Provisional Patent Application 60/692,371 filed Jun. 21, 2005.

### FIELD OF THE INVENTION

This invention relates to a wireless battery charging system and method.

### BACKGROUND OF THE INVENTION

Many of today's mobile wireless devices, such as cell phones, are battery powered and therefore require battery maintenance either by replacing or recharging the battery assuming the battery is rechargeable. Battery maintenance is an annoyance. Increasing use of battery powered mobile wireless devices increases not only maintenance requirements but also the annoyance associated with battery maintenance. Consequently there is a need for a battery recharging system and method for recharging mobile battery operated wireless devices that reduces the annoyance of battery maintenance.

Self-structuring antenna systems are already known. For instance, U.S. Pat. No. 6,175,723 B1 issued to Edward Joseph Rothwell, III, Jan. 16, 2001, discloses a self-structuring antenna system with a switchable antenna array. The antenna array comprises a plurality of antenna elements that are selectively electrically connectable to each other by a series of switch elements so that the physical shape of the antenna array can be altered. The antenna elements include wires, where the wires of adjacent antenna elements are connected by a mechanical or solid state switch element. One or more feed points are electrically connected to predetermined locations within the antenna array and to a receiver associated with the antenna array. A feed back signal from the receiver provides an indication of signal reception and antenna performance. The feed back signal is applied to a computer that selectively opens and closes the switch elements. An algorithm is used to program the computer so that the opening and closing of the switch elements attempts to achieve antenna optimization and performance.

The existence of self-structuring antenna systems provide an opportunity for recharging batteries in battery operated wireless devices remotely, particularly for recharging mobile, battery operated wireless devices that include a transceiver, such as a cell phone.

### SUMMARY OF THE INVENTION

A wireless battery charging system uses an electromagnetic energy system, preferably a dedicated electromagnetic radio frequency (RF) energy system, to remotely charge batteries in battery operated wireless devices. The system comprises a self-structuring antenna (SSA) system that monitors an assigned area of coverage and determines the battery status of a wireless device within the assigned area of coverage. If appropriate, the system then transmits electromagnetic energy to the battery operated wireless device to charge the battery. The system also preferably communicates to this wireless device the location of a near by electromagnetic near-field charging cradle if a fast charge is needed. The system also preferably notifies this wireless device if battery replacement is required.

### BRIEF DESCRIPTION OF THE DRAWING

FIG. 1 is a schematic drawing of a wireless battery charging system of the invention; and

FIG. 2 is a flow diagram of a method of charging wireless devices according to the invention.

### DETAILED DESCRIPTION OF PREFERRED EMBODIMENT

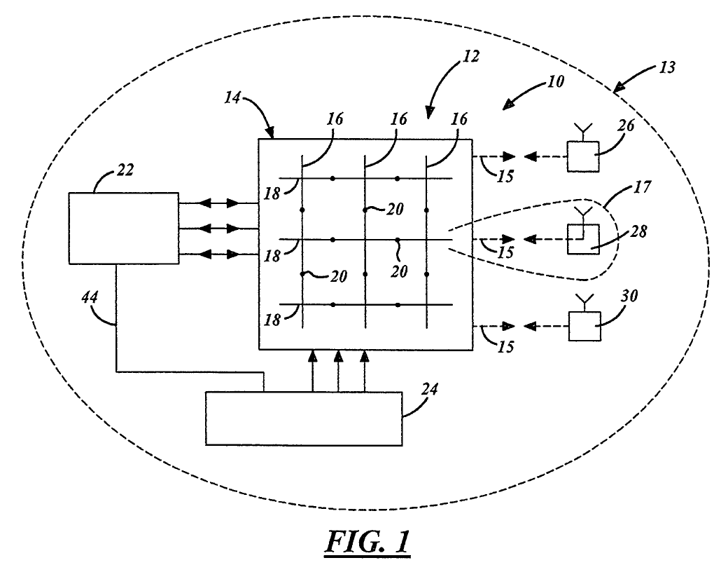

Referring now to FIG. 1, a schematic drawing of a wireless battery charging system 10 of the invention comprises a self-structuring antenna system 12 that is a modification of the self-structuring antenna system disclosed in U.S. Pat. No. 6,175,723 B1 issued to Edward Joseph Rothwell, III, Jan. 16, 2001.

Self-structuring antenna (SSA) system 12 has a switchable antenna array 14 that comprises a plurality of antenna elements 16 and 18 that are selectively electrically connectable to each other by a series of switch elements 20 so that the physical shape of the antenna array can be altered. One or more feed points are electrically connected to predetermined locations within the antenna array and to a transceiver 22 (also known as a transmitter-receiver) associated with the antenna array 14. A feed back signal from the transceiver 22 provides an indication of signal reception and antenna performance. The feed back signal is applied to a computer 24 that selectively opens and closes the switch elements 20. An algorithm is used to program the computer 24 so that the opening and closing of the switch elements 20 attempts to achieve antenna optimization and performance.

The SSA system 12 uses a wide antenna beam to monitor a large area of coverage such as the area indicated by dashed circle 13. The SSA system 12 also has the ability to detect and communicate with any compatible wireless device within the large area of coverage that has a transceiver or the like, as indicated by the dashed lines 15. For this detection and two-way communication, the SSA system 12 preferably uses a low data rate (kilo-megabits/sec) sub-system, such as Bluetooth, 802.11b, 802.11a, ZigBee, and/or other appropriate RF communication bands to detect and communicate with any wireless device within the coverage area.

FIG. 1 illustrates cell phones 26 and 28 and a charging cradle 30. Cell phones 26 and 28 are mobile, battery powered wireless devices that are equipped with rechargeable or storage batteries and transceivers. The charging cradle 30 is a remote universal charging station that will fast charge or trickle charge any compatible wireless device placed in the cradle.

Each of the battery operated wireless devices, such as cell phones 26 and 28 is equipped with the following: (1) any suitable battery charging circuit (not shown); (2) any suitable battery monitor that indicates the condition of the storage battery (not shown); and (3) any suitable sensor that is responsive to the transmitted signal of the antenna array 12, and that provides an indication of the strength of the transmitted signal of the antenna array 12 (not shown).

The two-way communication between the SSA battery charging system 10 and any wireless device within the monitoring area 13, such as cell phones 26 or 28, determines the condition of the battery within the wireless device, i.e. the wireless device transmits information regarding its battery to the wireless battery charging system 10, with the battery monitor information being evaluated either by the device prior to transmission or by the wireless battery charging system 10 upon receipt of the information. If the condition of the battery of the wireless device, for instance the battery of the wireless device 28 is acceptable, that is the battery has a minimum predetermined remaining life, then no action is taken by the wireless battery charging system 10. But, if condition of the battery is such that the battery should be recharged, the SSA system 12 of the wireless battery charging system 10, generates a narrow antenna beam and directs the narrow antenna beam at the wireless device 28 with the battery that needs to be charged as indicated by the dashed loop 17. If the condition of the battery is such that the battery should be fast charged, the system 10 preferably generates a notification signal to the wireless device 28 of the location of a near by charging cradle 30. If the battery requires replacement, the system 10 preferably sends a notification signal that battery replacement is required to the wireless device 28.

Once two-way communication is established and the SSA system 12 directs a narrow antenna beam for recharging the battery of the wireless device 28, the wireless device 28, transmits information regarding the strength of the beam 17 that is transmitted by the wireless battery recharging system 10. This information is feed to the computer 24 which then adjusts the antenna array 14 to provide an efficient configuration for the task at hand, particularly if the antenna array 14 is in the power transfer mode.

The narrow antenna beam 17 focuses as much electromagnetic energy as possible at the wireless device 28, to reduce energy waste, and improve efficiency. The battery of the wireless device 28 is preferably charged at a radio frequency and at a low rate (e.g., trickle charge) to minimize electromagnetic exposure concerns.

In addition, several individual remote wireless battery charging systems can be formed into an SSA charging network (e.g., much like a cell phone network) that tracks each wireless device as it moves from one assigned monitoring and charging area into another assigned area. Thus, as a wireless device is moved from one assigned area to another assigned area, the wireless device continues to be charged by the SSA charging network that dynamically responds (reconfigures) its charging capabilities to the new location of the wireless device. In addition, both the wireless device and the SSA charging network preferably work in partnership to make the handoff for one assigned area to another assigned area known to the wireless device user. For example, if the wireless device has a global positioning system (GPS) capability then this information could be used to determine the absolute location of the wireless device for use by the SSA network.

As stated above, if the condition of a battery is such that the battery should be fast charged, the battery charging system 10 preferably generates a notification signal to the wireless device of the location of the charging cradle 30 that can recharge a wireless device, such as the cell phone 26 or 28. The charging cradle 30 requires that the wireless device be placed on a charging pad that uses near-field SSA technology to transfer energy to the battery of the wireless device. The near-field SSA system communicates with the wireless device and determines its battery status. The near-field SSA system of the charging cradle 30 alters its geometry to provide efficient energy transfer between itself and the wireless device. The near-field SSA system of the charging cradle 30 allows much higher charging rates and also preferably communicates the battery status of the wireless device in the cradle to the wireless battery charging system 10.

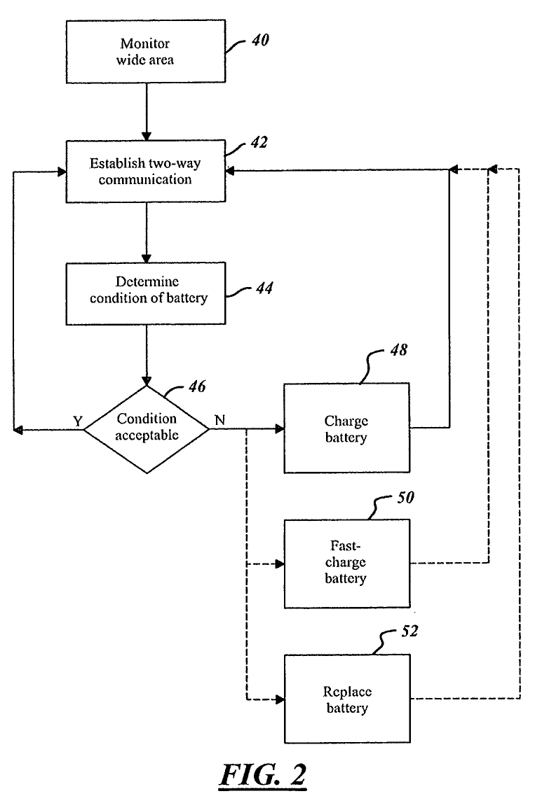

Thus the wireless battery charging system 10 provides the following method of wireless battery charging as illustrated and explained in connection with the flow diagram of FIG. 2.

The wireless battery charging system monitors a wide area and detects the presence of at least one wireless device within the area with a wireless charging device having a SSA antenna array as briefly noted at 40 in FIG. 2.

Two-way communication is established between the wireless charging device and the wireless device detected in the monitoring area as briefly noted at 42 in FIG. 2.

The condition of the battery in the detected wireless device is determined via the two-way communication that has been established between the wireless battery charging device and the detected wireless device as briefly noted at 44 in FIG. 2.

If the condition is acceptable, no action is taken as briefly noted at 46 in FIG. 2. The two-way communication is preferably maintained to continue monitoring the detected wireless device as illustrated in FIG. 2

If the condition is not acceptable and the battery requires recharging then the battery charging system generates a narrow energy beam directed at the detected wireless device while the wireless device transmits information regarding the strength of the narrow energy beam to the wireless charging system and the wireless charging device adjusts the SSA antenna array to provide an efficient configuration for focusing the narrow energy bean on the detected wireless device constantly as it receives information from the detected wireless device as briefly noted at 48 in FIG. 2. The two-way communication that is used during the charging process is preferably maintained after the charging is completed to continue monitoring the detected wireless device as illustrated in FIG. 2.

As indicated above, the wireless battery charging system 10 may include optional features in which case the method of wireless charging may also include additional optional steps. The first optional step is briefly noted at 50 in FIG. 2. With this optional step when the condition of the battery is determined at 44 and the condition is not acceptable, two alternatives are provided. If the battery merely requires recharging then the battery is simply recharged as before. However, if the battery requires fast recharging then the wireless charging device generates and sends a notification signal to the detected wireless device of a nearby location or locations of a charging cradle as briefly noted at 50 in FIG. 2

When the detected wireless device is placed in the cradle, communication between the charging system of the cradle and the detected wireless device is established, the status of the battery determined and monitored and the battery is fast charged (unless the detected wireless device is removed too soon.) Preferably, the wireless battery charging system also monitors the charging cradle and detects the presence of the detected wireless device on its charging pad.

The charging cradle is preferably a universal charging cradle that comprises an SSA electromagnetic near-field charging structure that alters its electromagnetic coupling with the wireless device to maximize and control energy transfer.

After the detected wireless device is fast charged in the cradle, the two-way communication of the detected wireless device with the wireless charging device is preferably maintained to continue monitoring the detected wireless device as illustrated in FIG. 2.

Another optional step is briefly noted at 52 in FIG. 2. With this optional step when the condition of the battery of the battery is determined at 44 and the condition is not acceptable, alternatives are also provided. If the battery merely requires recharging then the battery is simply recharged as before. However, if the battery requires replacement, then the wireless charging device generates and sends a notification signal to the detected wireless device that replacement is required as briefly noted at 52 in FIG. 2. This signal can also be sent to another location for monitoring purposes. The two-way communication of the detected wireless device with the wireless charging device is preferably maintained to continue monitoring the detected wireless device and recognize the battery replacement as illustrated in FIG. 2.

Thus the wireless battery charging method of the invention involves a basic method that can be used alone or together with a fast charge option and/or a replace option.

It will be readily understood by those persons skilled in the art that the present invention is susceptible of broad utility and application. Many embodiments and adaptations of the present invention other than those described above, as well as many variations, modifications and equivalent arrangements, will be apparent from or reasonably suggested by the present invention and the foregoing description, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the following claims and the equivalents thereof.

We claim:

1. A wireless battery charging system comprising:
a self-structuring antenna system for monitoring a wide area and detecting wireless devices within the area,
a transceiver for establishing two-way communication with a wireless device detected with the area, and
a computer for adjusting the self-structuring antenna system to focus an electromagnetic beam directed to the wireless device according to information received from the wireless device detected within the area.

2. The wireless battery charging system as defined in claim 1 further including at least one cradle for recharging a wireless device having a battery.

3. A method of charging wireless devices remotely comprising:
monitoring a wide area and detecting the presence of wireless devices within the area with a wireless charging device having a SSA antenna array;
establishing two-way communication between the wireless charging device and at least one wireless device that is detected in the monitoring area;
determining the condition of a battery in the wireless device via the two-way communication between the wireless battery charging device and the wireless device; and
generating a narrow energy beam by the wireless battery charging device directed at the wireless device if the battery requires recharging while the wireless device transmits information regarding the strength of the narrow energy beam to the wireless recharging system constantly and the wireless recharging device adjusts the SSA antenna array to provide an efficient configuration for focusing the narrow energy beam on the wireless device constantly as it receives the information from the wireless device.

4. The method as defined in claim 3 wherein the wireless battery charging device generates and sends a notification signal to the wireless device of a near by location of a charging cradle in lieu of generating a narrow energy beam if the battery requires fast recharging.

5. The method as defined in claim 4 wherein the wireless device is placed in the charging cradle.

6. The method as defined in claim 3 wherein the wireless battery charging device generates and sends a notification signal to the wireless of the need of replacing the battery in lieu of generating a narrow beam if replacement of the battery is required.

7. The method as defined in claim 3 wherein the wireless battery charging device generates and sends a notification signal to the wireless device of a near by location of a charging cradle in lieu of generating a narrow energy beam if the battery requires fast recharging or the wireless battery charging device generates and sends a notification signal to the wireless of the need of replacing the battery in lieu of generating a narrow beam if replacement of the battery is required.

8. A method of wireless battery charging comprising;
monitoring an assigned area for battery operated wireless devices electromagnetically;
detecting a particular battery operated wireless device in the assigned area;
determining the status of the battery in the detected battery operated wireless device; and
charging the battery of the detected wireless device electromagnetically if the status is below a predetermined amount.

9. The method as defined in claim 8 wherein the assigned area is monitored electromagnetically by a self-structuring antenna.

10. The method as defined in claim 9 wherein the assigned area is monitored by a self-structuring antenna that hands off the battery charging process as the wireless device moves from the monitored area to an adjacent area that is monitored electromagnetically by a self structuring antenna so that a wireless battery charging network is established to allow continuous battery charging as a wireless devise is moved from one monitored area to another.

11. The method as defined in claim 9 wherein the assigned area is monitored by a self-structuring antenna that detects a wireless device in need of a fast charge and notifies the wireless device of the location of a near by charging cradle.

12. The method as defined in claim 9 wherein assigned area is monitored by a self-structuring antenna that detects a wireless device in need of replacement and notifies the battery of the wireless device requires replacement.

13. The method as defined in claim 12 wherein the self structuring antenna notifies another location of the need for replacement.

14. A method of monitoring battery operated devices for battery charging or replacement comprising;
monitoring an assigned area for battery operated devices electromagnetically;
detecting at least one battery operated device in the assigned area;
determining the status of the battery in the detected battery operated device; and
replacing or charging the battery of the detected device if the status is below a predetermined amount.
